(19) United States
(12) Patent Application Publication
(10) Pub. No.: US 2026/0219026 A1
(43) Pub. Date: Jul. 30, 2026

(54) INSTRUMENT SENSOR DEVICE

(71) Applicant: Proterial, Ltd., Tokyo (JP)

(72) Inventors: Yohei SHIRAKAWA, Tokyo (JP); Takahiro SUGIYAMA, Tokyo (JP); Yoshiaki YANAGISAWA, Tokyo (JP)

(73) Assignee: Proterial, Ltd., Tokyo (JP)

(21) Appl. No.: 19/461,010

(22) Filed: Jan. 27, 2026

(30) Foreign Application Priority Data
Jan. 29, 2025 (JP) 2025-012771

(51) Int. Cl. G01B 7/30; G01D 5/20

(52) U.S. Cl. CPC G01B 7/30; G01D 5/20

(57) ABSTRACT

An instrument sensor device for detecting a rotational position of a pointer of an instrument, including a scale plate provided with scale markings, a transparent cover covering the scale plate, and the pointer arranged between the scale plate and the transparent cover and rotatable about a rotation axis within a predetermined angular range, is configured to be mounted on the transparent cover of the instrument and provided with a transparent sheet-like base material; and a plurality of coils formed of a wiring pattern provided on the base material, wherein the plurality of coils includes an excitation coil that generates an alternating magnetic field and a detection coil in which voltage is induced by the alternating magnetic field, and wherein a magnitude of an induced voltage in the detection coil varies according to the rotational position of the pointer.

### CROSS-REFERENCE TO RELATED APPLICATIONS

The present application is based on Japanese patent application No. 2025-012771 filed on Jan. 29, 2025, the entire contents of which are incorporated herein by reference.

### TECHNICAL FIELD

The present invention relates to an instrument sensor device (a sensor device for instruments) configured to be mounted on an instrument cover to detect a rotational position of a pointer of the instrument.

### BACKGROUND ART

Plants that manufacture chemical products, for example, are equipped with numerous instruments, such as pressure gauges. Conventionally, workers would patrol the plants to visually confirm the measured values, such as pressure, displayed on these instruments. To eliminate this labor-intensive task, devices are configured to detect the pointer position on an analog meter with a scale plate and a pointer, and to transmit the detection result as an electrical signal (see, e.g., Patent Literatures 1 and 2).

An IC tag unit for an instrument described in Patent Literature 1 has a conductive target attached near a center axis of a pointer and a proximity sensor having a detection coil. The conductive target is made of a sheet with a spiral conductive pattern formed on it, and the sheet is affixed to the pointer via an adhesive layer. The proximity sensor is positioned facing the conductive target on the inner surface (a surface on the scale plate side) of the transparent cover plate of the instrument and is connected to the IC tag equipped with an IC chip and an antenna. When the pointer rotates, the thickness of the conductive pattern in a portion approaching the detection coil of the proximity sensor changes, enabling detection of the rotation angle of the pointer. The detected information is transmitted wirelessly via the IC tag.

An instrument sensor described in Patent Literature 2 has an imaging device including a camera module composed of a CCD camera and an illuminator, a cylindrical light-shielding casing covering the imaging device, and a battery-driven terminal device using a battery for its power source. The imaging device and the battery-driven terminal device are connected by a connection cable extending outside the light-shielding casing. The light-shielding casing is attached to an outer surface at a center of a transparent cover of the instrument using a double-sided tape. The battery-driven terminal device comprises an image analysis unit that analyzes images of the pointer transmitted from the imaging device to calculate an angle of the pointer, and a communication device that transmits data regarding the angle of the pointer to an external device via a network.

### PRIOR ART LITERATURE

### Citation List

Patent Literature 1: WO2017/195251.

Patent Literature 2: JP2022-032602A.

### SUMMARY OF THE INVENTION

According to the description in Patent Literature 1, attaching the instrument IC tag unit to the instrument requires removing the transparent cover plate from the instrument and attaching a conductive target to the pointer, making the work labor-intensive. Furthermore, the instrument IC tag unit cannot be attached to an instrument whose transparent cover plate is configured to be unremovable.

According to the description in Patent Literature 2, an instrument sensor can be attached without removing the transparent cover from the instrument, but the inclusion of the CCD camera and the image analysis unit results in high costs. In other words, there was a difficult challenge in achieving low cost. Furthermore, since the cylindrical light-shielding casing is attached to the center of the transparent cover, when a worker visually inspects the pointer of the instrument, the light-shielding casing may obscure the pointer of the instrument depending on the viewing angle, which makes it difficult for the worker to visually inspect the pointer. In other words, there was also an issue of poor visibility of the pointer.

Accordingly, it is an object of the present invention to provide an instrument sensor device that enables cost reduction as well as good visibility of the pointer.

In order to solve the above problems, one aspect of the present invention provides an instrument sensor device for detecting a rotational position of a pointer of an instrument, including a scale plate provided with scale markings, a transparent cover covering the scale plate, and the pointer arranged between the scale plate and the transparent cover and rotatable about a rotation axis within a predetermined angular range,

the instrument sensor device being configured to be mounted on the transparent cover of the instrument and comprising:
a transparent sheet-like base material; and
a plurality of coils formed of a wiring pattern provided on the base material,
wherein the plurality of coils includes an excitation coil that generates an alternating magnetic field and a detection coil in which voltage is induced by the alternating magnetic field, and
wherein a magnitude of an induced voltage in the detection coil varies according to the rotational position of the pointer.

### Advantageous Effects of the Invention

According to the present invention, it is possible to provide an instrument sensor device that enables cost reduction as well as good visibility of the pointer.

### BRIEF DESCRIPTION OF THE DRAWINGS

FIG. 1 is a schematic diagram showing an example of using an instrument sensor device according to an embodiment of the present invention.

FIG. 2 is an explanatory diagram showing an example configuration of a leaky coaxial cable.

FIG. 3 is a front view showing an instrument and the instrument sensor device.

FIG. 4 is a cross-sectional view taken along the line A-A in FIG. 3.

FIG. 5 is a cross-sectional view of the instrument sensor device.

FIG. 6 is a wiring diagram showing the front-side wiring pattern and the back-side wiring pattern superimposed.

FIG. 7 is a wiring diagram showing the front-side wiring pattern with the back-side wiring pattern omitted.

FIG. 8 is a wiring diagram showing the back-side wiring pattern with the front-side wiring pattern omitted.

FIG. 9 is a graph showing an example of the relationship between supply voltage supplied to an excitation coil and induced voltage induced in a first detection coil and a second detection coil.

FIG. 10 is a graph showing the relationship between peak voltage, which is a peak value of the induced voltage induced in the first detection coil, and a pointer angle.

FIG. 11 is a graph showing the relationship between peak voltage, which is a peak value of the induced voltage induced in the second detection coil, and the pointer angle.

FIG. 12 is a block diagram showing a functional configuration of an electrical circuit unit.

FIG. 13A is a graph showing the relationship between the pointer angle and the peak voltage of the induced voltage induced in the first detection coil and the second detection coil based on electromagnetic field simulation.

FIG. 13B is a graph showing the relationship between an actual pointer angle and an estimated pointer angle calculated based on the peak voltage shown in FIG. 13A.

FIG. 13C is a graph showing an error in the estimated pointer angle shown in FIG. 13B.

### DETAILED DESCRIPTION OF THE INVENTION

### Embodiment

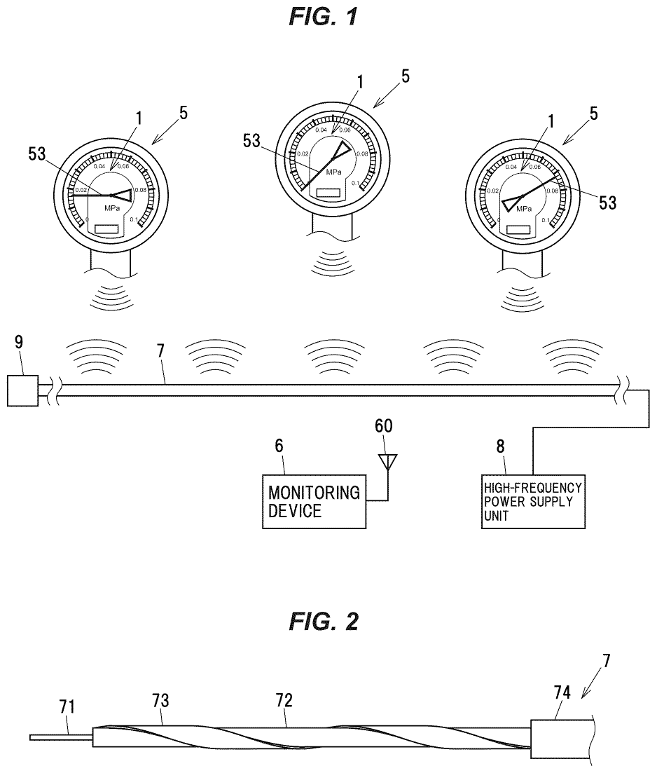

FIG. 1 is a schematic diagram showing an example of using the instrument sensor device 1 according to the embodiment of the present invention in a plant. The instrument sensor device 1 is attached to each of a plurality of instruments 5 installed inside the plant. The instrument 5 is, for example, a pressure sensor detecting the pressure of a gas or liquid, but the instrument sensor device 1 can be attached to an instrument other than a pressure sensor. The instrument sensor device 1 detects a rotational position of a pointer 53 of the instrument 5 and wirelessly transmits information about the rotational position of the pointer 53 to a monitoring device 6. The monitoring device 6 has a receiving antenna 60 that receives radio waves from the instrument sensor device 1.

Each of the instruments 5 is positioned near a leaky coaxial cable 7. The leaky coaxial cable 7, also known as “LCX,” is a coaxial cable designed to leak radio waves externally. The instruments 5 are positioned within the range where the radio waves from the leaky coaxial cable 7 can reach. A high-frequency power supply unit 8 is connected to one end of the leaky coaxial cable 7, and a terminating resistor 9 is connected to the other end of the leaky coaxial cable 7.

### (Configuration of the Leaky Coaxial Cable 7)

FIG. 2 is an explanatory diagram showing an example configuration of the leaky coaxial cable 7. The leaky coaxial cable 7 comprises an inner conductor 71, an insulator 72 covering the inner conductor 71, an outer conductor 73 made of a strip of metal foil wound helically around the outer periphery of the insulator 72, and a sheath 74 covering the outer peripheries of the insulator 72 and the outer conductor 73. Power input from the high-frequency power supply unit 8 into the leaky coaxial cable 7 propagates toward a terminating resistor 9 while leaking out of the leaky coaxial cable 7 as radio waves. The radio waves leaking from the leaky coaxial cable 7, for example, are circularly polarized waves in the 920 MHz band.

### (Configuration of the Instrument 5)

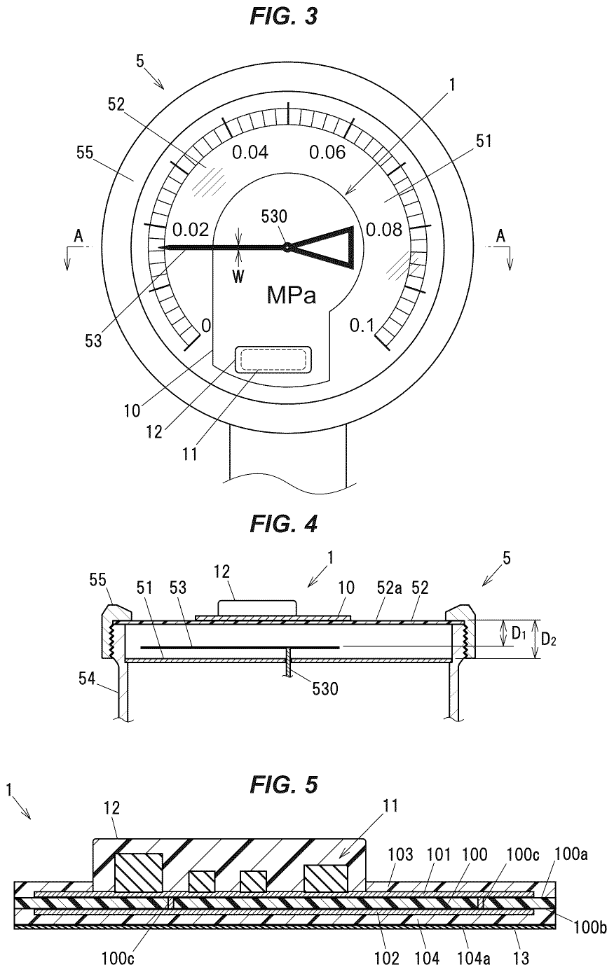

FIG. 3 is a front view showing the instrument 5 and the instrument sensor device 1. FIG. 4 is a cross-sectional view taken along the line A-A in FIG. 3. FIG. 5 is a cross-sectional view of the instrument sensor device 1. The instrument 5 comprises a circular scale plate 51 with scale markings, a transparent cover 52 covering the scale plate 51, a pointer 53 positioned between the scale plate 51 and the transparent cover 52, a casing 54, and a bezel 55 threaded onto the casing 54 to secure the transparent cover 52 to the casing 54. The transparent cover 52 is made of, e.g., a glass plate or an acrylic plate. The pointer 53 is made of, for example, an electrically conductive metal, e.g., iron, aluminum, and the like, and rotates within a predetermined angular range about a rotation axis 530. The scale plate 51 has a portion along its circumferential direction where no scale markings are provided, and the instrument 5 is installed such that the portion without scale markings faces downward in the vertical direction.

### (Configuration of the Instrument Sensor Device 1)

The instrument sensor device 1 is attached to an outer surface 52a of the transparent cover 52. The outer surface 52a is the surface of the transparent cover 52 opposite to the scale plate 51 side. As shown in FIG. 5, the instrument sensor device 1 comprises a transparent flexible substrate 10, an electrical circuit unit 11 consisting of multiple electronic components mounted on the transparent flexible substrate 10, and a sealing member 12 that seals the electrical circuit unit 11.

The transparent flexible substrate 10 comprises a base material 100 which is a transparent sheet, a front-side wiring pattern 101 formed on a front surface 100a of the base material 100, a back-side wiring pattern 102 formed on a back surface 100b of the base material 100, a front-side cover layer 103 covering the front surface 100a of the base material 100 and the front-side wiring pattern 101, and a back-side cover layer 104 covering the back surface 100b of the base material 100 and the back-side wiring pattern 102. The front-side wiring pattern 101 and the back-side wiring pattern 102 are connected at multiple locations by through-holes 100c that penetrate the base material 100. On the surface 104a of the back-side cover layer 104, which is located opposite to the base material 100, an adhesive layer 13 is provided for attaching the transparent flexible substrate 10 to the transparent cover 52 of the instrument 5.

The base material 100, the front-side cover layer 103, and the back-side cover layer 104 are made of a transparent resin with enhanced transparency. This resin is, for example, made of polyimide (PI) or polyethylene terephthalate (PET). The transparency of the base material 100, the front-side cover layer 103, and the back-side cover layer 104 allows the scale plate 51 and the pointer 53 of the instrument 5 to be visible through the transparent flexible substrate 10. The electrical circuit unit 11 and the sealing member 12 are provided in a portion that does not overlap with the scale markings of the scale plate 51 when viewing the instrument 5 from a direction perpendicular to the scale plate 51. Furthermore, in the present embodiment, as shown in FIG. 3, the entire transparent flexible substrate 10 is positioned in a portion that does not overlap with the scale markings of the scale plate 51.

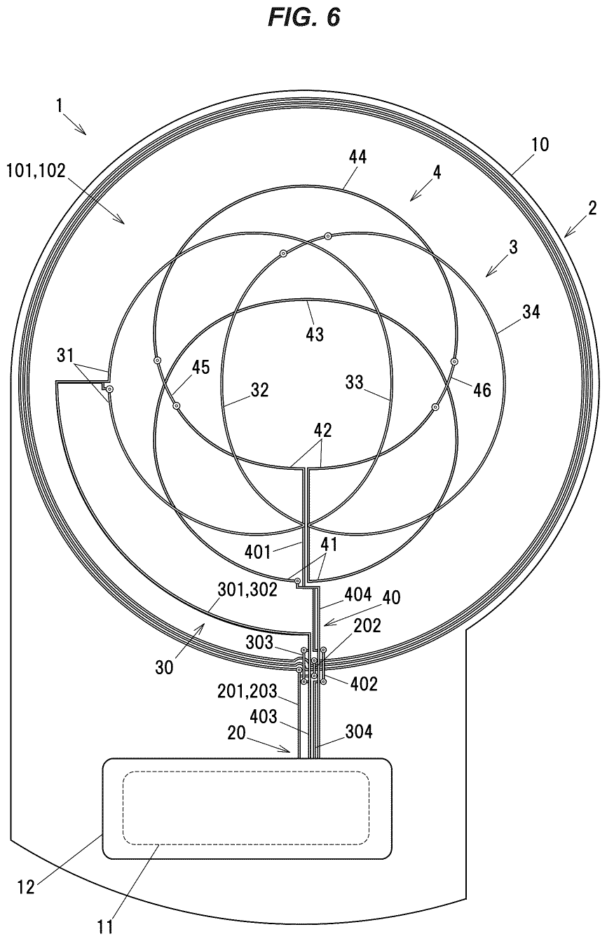

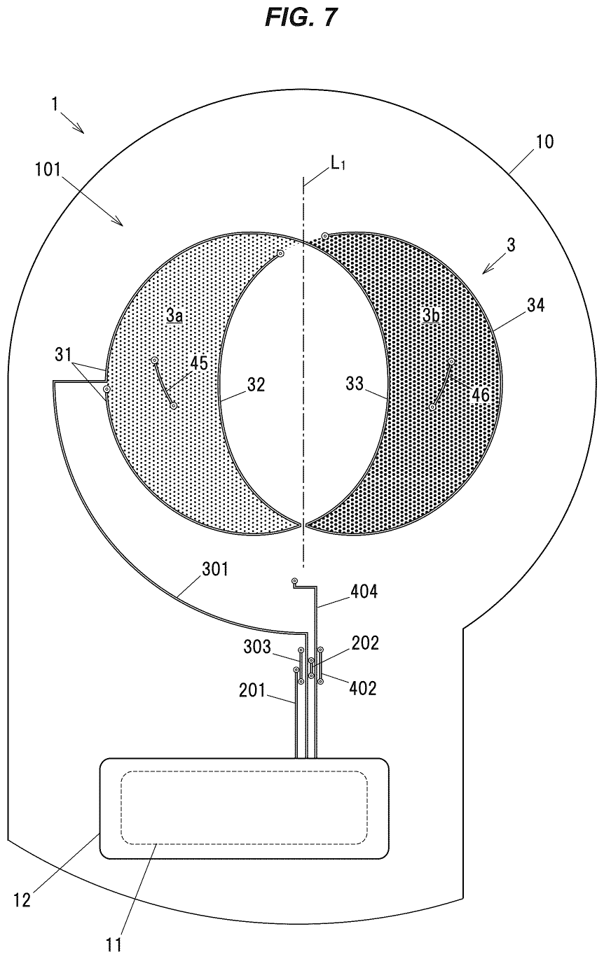

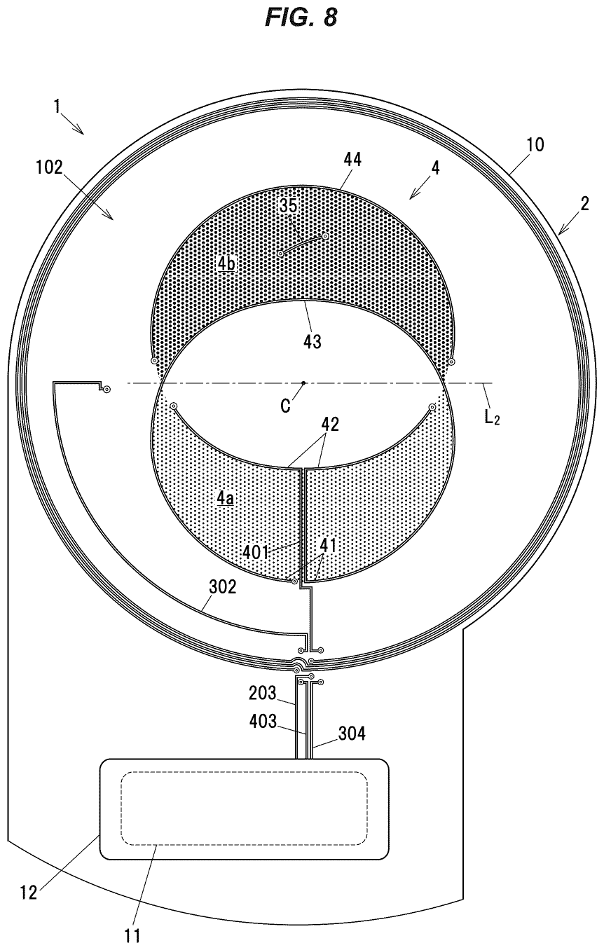

Next, the configuration of the front-side wiring pattern 101 and the back-side wiring pattern 102 of the transparent flexible substrate 10 will be described with reference to FIG. 6 through FIG. 8. FIG. 6 is a wiring diagram showing the front-side wiring pattern 101 and the back-side wiring pattern 102 superimposed. FIG. 7 is a wiring diagram showing the front-side wiring pattern 101 with the back-side wiring pattern 102 omitted. FIG. 8 is a wiring diagram showing the back-side wiring pattern 102 with the front-side wiring pattern 101 omitted.

The transparent flexible substrate 10 includes a plurality of coils formed of the front-side wiring pattern 101 and the back-side wiring pattern 102. The plurality of coils include an excitation coil 2 that generates an alternating magnetic field, and two detection coils 3, 4, in each of which voltage is induced by the alternating magnetic field generated by the excitation coil 2. In other words, in the present embodiment, the excitation coil 2 and the two detection coils 3, 4 are formed of the front-side wiring pattern 101 and the back-side wiring pattern 102.

The magnitude of the induced voltage in each of the two detection coils 3, 4 changes according to the rotational position of the pointer 53 having electrical conductivity. Therefore, it is possible to detect the rotational position of the pointer 53 based on the magnitude of the induced voltage in each of the two detection coils 3, 4. Details of a method for detecting the rotational position of the pointer 53 will be described later. Hereinafter, the two detection coils 3 and 4 are referred to as a “first detection coil 3” and a “second detection coil 4.” Also, in the following description, “up,” “down,” “left,” and “right” refer to the respective directions when viewed from the front of the instrument 5 and the instrument sensor device 1, which are installed such that the portion of the scale plate 51 without scale markings is vertically downward.

The first detection coil 3 is mainly formed of the front-side wiring pattern 101, while the second detection coil 4 is mainly formed of the back-side wiring pattern 102. The first detection coil 3 comprises a left portion 3a, shown in light gray in FIG. 7 and a right portion 3b, shown in dark gray in FIG. 7. The left portion 3a and the right portion 3b have symmetrical shapes that are line-symmetrical with respect to the symmetry axis L₁ shown by a dash-dotted line in FIG. 7. The second detection coil 4 has a lower portion 4a shown in light gray in FIG. 8 and an upper portion 4b shown in dark gray in FIG. 8. The lower portion 4a and the upper portion 4b have symmetrical shapes that are line-symmetrical with respect to the symmetry axis L₂ shown by a dash-dotted line in FIG. 8. The left portion 3a, the right portion 3b, the lower portion 4a, and the upper portion 4b are each crescent-shaped.

The first detection coil 3 is formed of the curved portions 31 to 34 of the front-side wiring pattern 101 and a bridge portion 35 of the back-side wiring pattern 102. The curved portions 31 and 32 form the left portion 3a, while the curved portions 33 and 34 form the right portion 3b. The bridge portion 35 connects the curved portion 32 and the curved portion 34 on the back surface 100b of the base material 100 via the through-hole 100c.

The second detection coil 4 is formed of the curved portions 41 to 44 of the back-side wiring pattern 102 and bridge portions 45, 46 of the front-side wiring pattern 101. The curved portions 41, 42 form the lower portion 4a, and the curved portions 43, 44 form the upper portion 4b. The bridge portion 45 connects one end of each of the curved portions 42 and 44 on the front surface 100a of a base material 100 via the through-hole 100c. The bridge portion 46 connects the other end of each of the curved portions 42 and 44 on the front surface 100a of the base material 100 via the through-hole 100c.

The excitation coil 2 is formed in a ring shape surrounding the first detection coil 3 and the second detection coil 4. In the present embodiment, the excitation coil 2 is formed of the back-side wiring pattern 102 and encircles the first detection coil 3 and the second detection coil 4 three times. A center point C of the excitation coil 2 coincides with a rotation axis 530 of the pointer 53 when viewed from the front of the instrument 5 and the instrument sensor device 1.

A connection line 20 is provided on the transparent flexible substrate 10 to connect both ends of the excitation coil 2 to the electrical circuit unit 11. The connection line 20 includes a connection line 201 connecting one end of the excitation coil 2 to the electrical circuit unit 11, and connection lines 202, 203 connecting the other end of the excitation coil 2 to the electrical circuit unit 11. The connection lines 201, 202 are formed of the front-side wiring pattern 101, and the connection line 203 is formed of the back-side wiring pattern 102.

Furthermore, the transparent flexible substrate 10 includes a first transmission line 30 for transmitting an output voltage of the first detection coil 3 to the electrical circuit unit 11, and a second transmission line 40 for transmitting an output voltage of the second detection coil 4 to the electrical circuit unit 11. The first transmission line 30 is formed of signal lines 301, 303 of the front-side wiring pattern 101 and signal lines 302, 304 of the back-side wiring pattern 102. The second transmission line 40 is formed of signal lines 401, 403 of the back-side wiring pattern 102 and signal lines 402, 404 of the front-side wiring pattern 101.

An alternating current is supplied to the excitation coil 2 from the electrical circuit unit 11. Magnetic flux of an alternating magnetic field generated by the excitation coil 2 due to this alternating current links with the left portion 3a and the right portion 3b of the first detection coil 3, and the lower portion 4a and the upper portion 4b of the second detection coil 4. Here, assuming the pointer 53 does not exist, a voltage induced in the left portion 3a of the first detection coil 3 and a voltage induced in the right portion 3b cancel each other out due to the alternating magnetic field generated by the excitation coil 2, resulting in the output voltage of zero for the first detection coil 3. Furthermore, the voltage induced in the lower portion 4a of the second detection coil 4 by the alternating magnetic field generated by the excitation coil 2 would cancel out the voltage induced in the upper portion 4b of the second detection coil 4, resulting in the output voltage of zero for the second detection coil 4.

The alternating magnetic field generated by the excitation coil 2 also links with the pointer 53. Eddy currents are generated in the pointer 53 by the alternating magnetic field generated by the excitation coil 2, and these eddy currents act to reduce the magnetic flux passing through the pointer 53. Consequently, in the area where the pointer 53 overlaps with the scale plate 51 of the instrument 5 and the instrument sensor device 1 when viewed from the front, the magnetic field strength in the transparent flexible substrate 10 becomes weaker than in other areas. Furthermore, as the pointer 53 rotates, the position where the magnetic field weakens changes according to its rotational position. Consequently, the induced voltage in the first detection coil 3 and the induced voltage in the second detection coil 4 vary according to the rotational position of the pointer 53. The induced voltage induced in the first detection coil 3 is output to the electrical circuit unit 11 as the output voltage of the first detection coil 3, and the induced voltage induced in the second detection coil 4 is output to the electrical circuit unit 11 as the output voltage of the second detection coil 4.

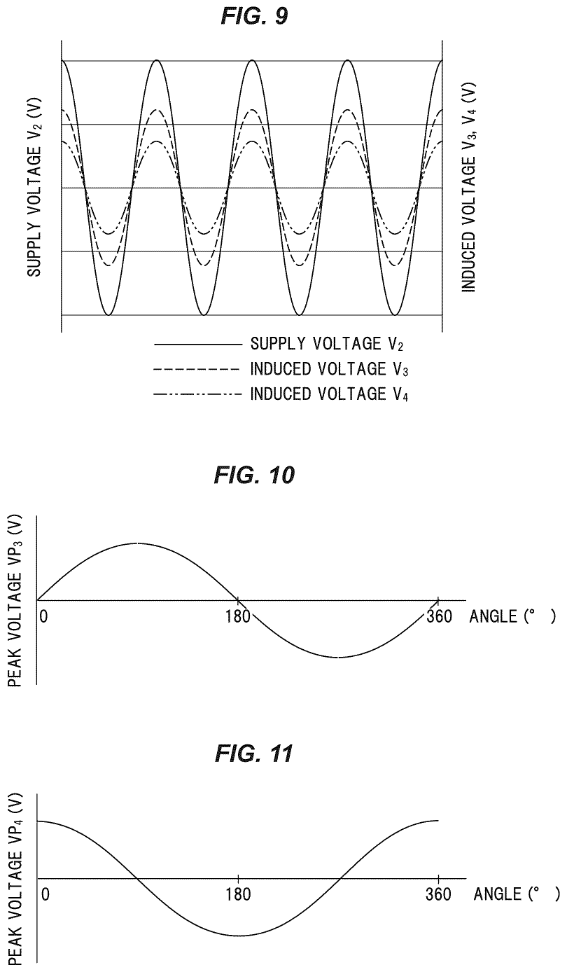

FIG. 9 is a graph showing an example of the relationship between the supply voltage V₂ supplied from the electrical circuit unit 11 to the excitation coil 2 when the pointer 53 is positioned where it overlaps the left portion 3a of the first detection coil 3 and the lower portion 4a of the second detection coil 4, and the induced voltages V₃, V₄ induced in the first detection coil 3 and the second detection coil 4, respectively. The horizontal axis of the graph in FIG. 9 shows time. The left vertical axis shows the supply voltage V₂ supplied to the excitation coil 2. The right vertical axis shows the induced voltage V₃ induced in the first detection coil₃ and the induced voltage V₄ induced in the second detection coil 4. In the example shown in FIG. 9, the supply voltage V₂ and the induced voltages V₃, V₄ are in phase. However, depending on the rotational position of the pointer 53, one or both of the induced voltages V₃, V₄ become out of phase with the supply voltage V₂. The frequency of the supply voltage V₂ is a frequency that does not interfere with the radio waves from the leaky coaxial cable 7.

FIG. 10 is a graph showing the relationship between a peak voltage VP₃, which is a peak value of the induced voltage V₃ induced in the first detection coil 3, and the angle of the pointer 53. FIG. 11 is a graph showing the relationship between a peak voltage VP₄, which is a peak value of the induced voltage V₄ induced in the second detection coil 4, and the angle of the pointer 53. The horizontal axis of the graphs shown in FIG. 10 and FIG. 11 sets the angle of the pointer 53 when it points directly downward in the vertical direction as 0°, and the angle of the pointer 53 when it points directly upward in the vertical direction as 180°.

In the graph shown in FIG. 10, the peak voltage VP₃ of the first detection coil 3 is positive when the induced voltage V₃ induced in the first detection coil 3 is in phase with the supply voltage V₂ supplied to the excitation coil 2, and negative when it is out of phase. Also, in the graph shown in FIG. 11, the peak voltage VP₄ of the second detection coil 4 is positive when the induced voltage V₄ induced in the second detection coil 4 is in phase with the supply voltage V₂ supplied to the excitation coil 2, and negative when it is out of phase.

As shown in FIG. 10 and FIG. 11, the phases of the magnitude change of the voltages induced in the first detection coil 3 and the second detection coil 4 when the pointer 53 rotates, are different from each other. In the present embodiment, this phase difference is 90°. Consequently, based on the induced voltages V₃ and V₄ induced in the first detection coil 3 and the second detection coil 4, respectively, the angle of the pointer 53, i.e., the rotational position of the pointer 53, can be uniquely determined by calculation.

### (Configuration of the Electrical Circuit Unit 11)

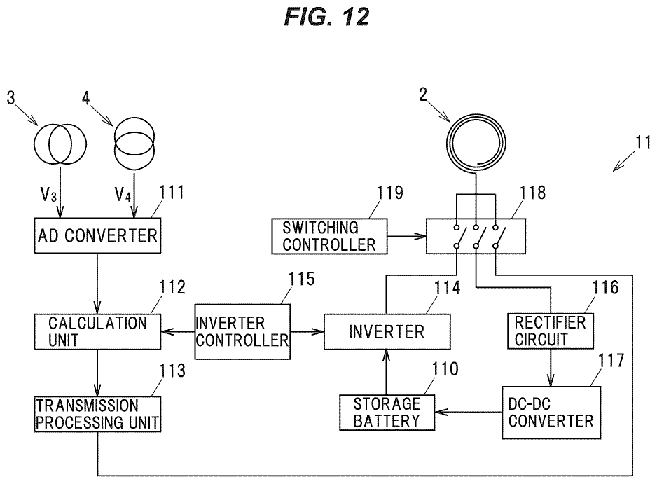

FIG. 12 is a block diagram showing the functional configuration of the electrical circuit unit 11. Functionally, the electrical circuit unit 11 comprises an AD converter 111, a calculation unit 112, a transmission processing unit 113, an inverter 114, an inverter controller 115 for controlling the inverter 114, a rectifier circuit 116, a DC-DC converter 117, a switching unit 118, a switching controller 119 that controls the switching unit 118, and a storage battery 110. The storage battery 110 is a rechargeable secondary battery and stores DC power. The AD converter 111, the calculation unit 112, the transmission processing unit 113, the inverter controller 115, and the switching controller 119 operate using electric power supplied from the storage battery 110.

The AD converter 111 converts the induced voltage V₃, which is the output voltage of the first detection coil 3, and the induced voltage V₄, which is the output voltage of the second detection coil 4, into digital values. The calculation unit 112 calculates the rotational position of the pointer 53 based on the magnitudes of the induced voltages V₃ and V₄ converted into digital values. The transmission processing unit 113 transmits the information regarding the rotational position of the pointer 53 calculated by the calculation unit 112 to the monitoring device 6. The inverter 114 switches the DC voltage output from the storage battery 110 to convert the DC voltage into an AC voltage, and supplies the AC voltage to the excitation coil 2 as the supply voltage V₂.

The inverter controller 115 outputs a switching signal to the inverter 114 to switch the on/off state of a switching element of the inverter 114, thereby controlling the inverter 114. The inverter controller 115 also outputs the switching signal to the calculation unit 112. The calculation unit 112 references the switching signal when calculating the rotational position of the pointer 53 to determine the peak voltages VP₃ and VP₄ of the induced voltages V₃ and V₄ in the first detection coil 3 and the second detection coil 4, respectively, and calculates the rotational position of the pointer 53.

In the present embodiment, the radio waves leaking from the leaky coaxial cable 7 are external radio waves, and electric power is generated from the external radio waves using the excitation coil 2, and the generated electric power is stored in the storage battery 110. As a configuration for this, the electrical circuit unit 11 includes the rectifier circuit 116 and the DC-DC converter 117 as power storage means. The rectifier circuit 116 rectifies the voltage generated in the excitation coil 2 by the external radio waves and converts it into a DC voltage. The DC-DC converter 117 converts the DC voltage converted by the rectifier circuit 116 into a voltage suitable for charging the storage battery 110. Furthermore, the inverter 114 energizes the excitation coil 2 using the electric power stored in the storage battery 110 by the rectifier circuit 116 and the DC-DC converter 117.

In the present embodiment, the calculation unit 112 calculates the rotational position of the pointer 53 using the electric power stored in the storage battery 110, and the transmission processing unit 113 transmits information about the rotational position of the pointer 53 using the electric power stored in the storage battery 110. In the present embodiment, the transmission processing unit 113 transmits the information of the rotational position of the pointer 53 using the excitation coil 2 as a transmission antenna. However, the information of the rotational position of the pointer 53 may also be transmitted using the first detection coil 3 or the second detection coil 4 as the transmission antenna. The frequency used by transmission processing unit 113 to transmit the rotational position information of pointer 53 is a frequency that does not interfere with the radio waves from the leaky coaxial cable 7.

The switching unit 118 has multiple switching elements, and switches the connection of the excitation coil 2 to one of the inverter 114, the transmission processing unit 113, and the rectifier circuit 116. The switching controller 119 outputs a switching signal to the switching unit 118, e.g., at predetermined time intervals, to switch the connection state of the switching unit 118. In a first connection state where the excitation coil 2 is connected to the inverter 114, the excitation coil 2 generates an alternating magnetic field using an alternating voltage output by the inverter 114. The calculation unit 112 then calculates the rotational position of the pointer 53 based on the magnitudes of the induced voltages V₃ and V₄. In a second connection state where the excitation coil 2 is connected to the transmission processing unit 113, the transmission processing unit 113 transmits information about the rotational position of the pointer 53 via the excitation coil 2. In a third connection state where the excitation coil 2 is connected to the rectifier circuit 116, the storage battery 110 is charged by a voltage generated in the excitation coil 2 due to the external radio waves.

In other words, the instrument sensor device 1 has a first operation mode to excite the excitation coil 2 to calculate the rotational position of the pointer 53, a second operation mode to transmit information about the rotational position of the pointer 53, and a third operation mode to store electric power obtained from the external radio waves in the storage battery 110. The first to third operation modes are sequentially switched.

### Results of Electromagnetic Field Simulation

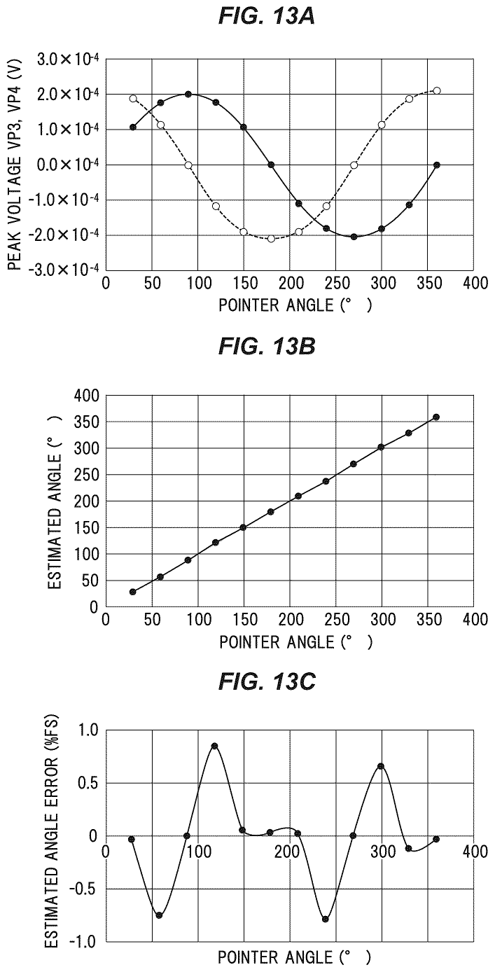

FIG. 13A is a graph showing the relationship between the pointer angle which is the angle of the pointer 53 relative to the scale plate 51, and the peak voltages VP₃ and VP₄ which are the peak values of the induced voltages V₃ and V₄ induced in the first detection coil 3 and the second detection coil 4, respectively, obtained from electromagnetic field simulation. The white circles (○) on the graph indicate the peak voltage VP₃, which is the peak value of the induced voltage V₃ induced in the first detection coil 3. The black circles (●) on the graph indicate the peak voltage VP₄, which is the peak value of the induced voltage V₄ induced in the second detection coil 4.

In this electromagnetic field simulation, a distance D₁ between the outer surface 52a of the transparent cover 52 and the pointer 53 (see FIG. 4) was set to 8 mm, and a distance D₂ between the outer surface 52a of the transparent cover 52 and the scale plate 51 (see FIG. 4) was set to 11.5 mm. The pointer 53 and the scale plate 51 were made of aluminum. A thickness of the pointer 53 was set to 0.5 mm, and a width W of the pointer 53 (see FIG. 3) was set to 1.0 mm. The thickness of the scale plate 51 was set to 1.0 mm. Also, the transparent cover 52 was made of glass with a thickness of 1.0 mm.

FIG. 13B is a graph showing the relationship between the pointer angle, which is an actual angle of the pointer 53 relative to the scale plate 51, and an estimated angle of the pointer 53 relative to the scale plate 51, which is calculated based on the peak voltages VP₃ and VP₄ shown in FIG. 13A. FIG. 13C is a graph showing an error in the estimated angle of the pointer 53 (estimated angle error) in FIG. 13B in % FS (full scale). As shown in FIG. 13B, the pointer angle and the estimated angle have a linear relationship. As shown in FIG. 13C, the errors in the estimated angle are kept below 1%.

### Advantageous Effect of the Embodiment

According to the embodiment described above, the instrument sensor device 1 can be mounted on the outer surface 52a of the transparent cover 52 without removing the transparent cover 52 from the instrument 5, thereby facilitating mounting the instrument sensor device 1 on the instrument 5. Furthermore, the rotational position of the pointer 53 can be detected by the excitation coil 2, the first detection coil 3, and the second detection coil 4, formed of the front-side wiring pattern 101 and the back-side wiring pattern 102 of the transparent flexible substrate 10, and therefore, the cost can be reduced, for example, compared with a case where a CCD camera is used as described in the above-mentioned Patent Literature 2.

Additionally, according to the embodiment described above, since the scale plate 51 and the pointer 53 of the instrument 5 are visible through the transparent flexible substrate 10, the electrical circuit unit 11 and the sealing member 12 can be positioned in areas not overlapping the scale markings of the scale plate 51 when viewed from a direction perpendicular to the scale plate 51. Therefore, even when viewed from a direction slightly inclined relative to the normal direction of the scale plate 51, the entire range from a minimum value to a maximum value of the scale markings, can be clearly seen from outside the transparent cover 52. Consequently, visibility of the pointer 53 can be improved, compared with a case where a cylindrical light-shielding exterior is installed at a center of the transparent cover as described in Patent Literature 2.

Furthermore, according to the embodiment described above, the storage battery 110 is charged by the voltage generated by the external radio waves, and each part of the electrical circuit unit 11 operates using the electric power supplied from the storage battery 110. Therefore, there is no need to run a power cable for supplying electric power to the instrument sensor device 1, facilitating an installation of the instrument sensor device 1. Also, since the rotational position information of the pointer 53 is transmitted wirelessly, there is no need to run a signal line cable for transmitting the rotational position information of the pointer 53, further facilitating the installation of the instrument sensor device 1.

### Summary of the Embodiments

Next, the technical concept understood from the above-described embodiments is described using the reference numerals and other symbols used in the embodiments. However, the reference numerals in the following description do not limit the components specified in the claims to the specific parts shown in the embodiments.

According to the first feature, an instrument sensor device 1 for detecting a rotational position of a pointer 53 of an instrument 5, including a scale plate 51 provided with scale markings, a transparent cover 52 covering the scale plate 51, and the pointer 53 arranged between the scale plate 51 and the transparent cover 52 and rotatable about a rotation axis 530 within a predetermined angular range, is configured to be mounted on the transparent cover 52 of the instrument 5 and includes a transparent sheet-like base material 100; and a plurality of coils 2, 3, 4 formed of a wiring pattern provided on the base material 100, wherein the plurality of coils 2, 3, 4 includes an excitation coil 2 that generates an alternating magnetic field and a detection coil 3, 4 in which voltage is induced by the alternating magnetic field, and wherein a magnitude of an induced voltage in the detection coil 3, 4 varies according to the rotational position of the pointer 53.

According to the second feature, the instrument sensor device 1 as described by the first feature, further includes a calculation unit 112 that calculates the rotational position of the pointer 53 based on the magnitude of the induced voltage.

According to the third feature, in the instrument sensor device 1 as described by the second feature, the detection coil in the plurality of coils 2, 3, 4 includes two detection coils 3, 4, wherein phases of change in magnitudes of voltages induced in the two detection coils 3, 4 when the pointer 53 rotates are different from each other, and wherein the calculation unit 112 calculates the rotational position of the pointer 53 based on the magnitudes of the induced voltages in the two detection coils 3, 4.

According to the fourth feature, the instrument sensor device 1 as described by the second feature, further includes a transmission processing unit 113 that transmits an information about the rotational position of the pointer 53 calculated by the calculation unit 112 using any of the plurality of coils 3, 4.

According to the fifth feature, the instrument sensor device 1 as described by the first feature, further includes a power storage means 116, 117 that generates electric power from external radio waves using the excitation coil 2 and stores a generated electric power in a storage battery 110.

According to the sixth feature, in the instrument sensor device 1 as described by the fifth feature, the excitation coil 2 is energized by the electric power stored in the storage battery 110. According to the seventh feature, the instrument sensor device 1 as described by the fourth feature, further includes a power storage means 116, 117 that generates electric power from external radio waves using the excitation coil 2, and stores generated electric power in a storage battery 110, and wherein the calculation unit 112 calculates the rotational position of the pointer 53 using electric power stored in the storage battery 110, while the transmission processing unit 113 transmits information about the rotational position of the pointer 53.

According to the eighth feature, the instrument sensor device 1 as described by the fifth feature, further includes a first operation mode to excite the excitation coil 2 and calculate the rotational position of the pointer 53, a second operation mode to transmit information about the rotational position of the pointer 53, and a third operation mode to store electric power generated from the external radio waves in the storage battery 110, wherein the first to third operation modes are sequentially switched.

The above description of the embodiments of the present invention does not limit the invention to the scope of the claims. Additionally, it should be noted that not all the combinations of features described in the embodiments are essential to the means for solving the problems of the invention.

1. An instrument sensor device for detecting a rotational position of a pointer of an instrument, including a scale plate provided with scale markings, a transparent cover covering the scale plate, and the pointer arranged between the scale plate and the transparent cover and rotatable about a rotation axis within a predetermined angular range,
the instrument sensor device being configured to be mounted on the transparent cover of the instrument and comprising:
a transparent sheet-like base material; and
a plurality of coils formed of a wiring pattern provided on the base material, wherein the plurality of coils includes an excitation coil that generates an alternating magnetic field and a detection coil in which voltage is induced by the alternating magnetic field, and
wherein a magnitude of an induced voltage in the detection coil varies according to the rotational position of the pointer.

2. The instrument sensor device according to claim 1, further comprising:
a calculation unit that calculates the rotational position of the pointer based on the magnitude of the induced voltage.

3. The instrument sensor device according to claim 2,
wherein the detection coil in the plurality of coils includes two detection coils,
wherein phases of change in magnitudes of voltages induced in the two detection coils when the pointer rotates are different from each other, and
wherein the calculation unit calculates the rotational position of the pointer based on the magnitudes of the induced voltages in the two detection coils.

4. The instrument sensor device according to claim 2, further comprising:
a transmission processing unit that transmits an information about the rotational position of the pointer calculated by the calculation unit using any of the plurality of coils.

5. The instrument sensor device according to claim 1, further comprising:
a power storage means that generates electric power from external radio waves using the excitation coil and stores a generated electric power in a storage battery.

6. The instrument sensor device according to claim 5, wherein the excitation coil is energized by the electric power stored in the storage battery.

7. The instrument sensor device according to claim 4, further comprising:
a power storage means that generates electric power from external radio waves using the excitation coil, and stores generated electric power in a storage battery, and
wherein the calculation unit calculates the rotational position of the pointer using a stored electric power in the storage battery, while the transmission processing unit transmits an information of the rotational position of the pointer.

8. The instrument sensor device according to claim 5, further comprising:
a first operation mode to excite the excitation coil and calculate the rotational position of the pointer,
a second operation mode to transmit an information of the rotational position of the pointer, and
a third operation mode to store the electric power generated from the external radio waves in the storage battery,
wherein the first to third operation modes are sequentially switched.
